(19) United States
(12) Patent Application Publication
(10) Pub. No.: US 2012/0085076 A1
(43) Pub. Date: Apr. 12, 2012

(54) System of Static Graphic Representation Applicable to Lawn Surfaces

(76) Inventor: Juan Miguel Mayordomo Vicente, Barcelona (ES)

(21) Appl. No.: 13/252,301

(22) Filed: Oct. 4, 2011

(30) Foreign Application Priority Data
Oct. 8, 2010 (BR) PI1004032-3

(51) Int. Cl. A01D 34/00

(52) U.S. Cl. 56/229

(57) ABSTRACT

System of static graphic representation applicable to lawn surfaces of natural or synthetic type, comprising a milling device having at least one helical drum with cutting means which permit cutting the grass of the lawn, including as well guiding means to be located on the lawn surface to guide the displacement of the milling device on the lawn surface, so as to obtain publicity representations by way of any character or graphic pattern by means of cutting and orientating the grass of the lawn.

The present invention refers to a system of static graphic representation applicable to lawn surfaces, incorporating remarkable improvements and advantages.

In other words, the invention provides the development of a new system of static graphic representation applicable to lawn surfaces, both natural and synthetic, having a continuous surface, or a surface made out of portions or tiles, the system being based in a milling device which permits to obtain publicity representations by way of any character or graphic pattern.

### BACKGROUND OF THE INVENTION

At present, a wide variety of publicity systems and devices are known. Particularly, since a few years, in sport stadiums, as for example sport fields for soccer, athletics, etc., provided with a natural or synthetic lawn surfaces, graphic representations are applied on the lawn, with a three dimensional effect by means of painting the surface of the lawn.

However, in practical terms, this type of graphic representation system has the main drawback that it requires a special painting equipment and needs a continuous maintenance due to the fact that the growth of the grass requires the renewed painting of the publicity representations.

### DESCRIPTION OF THE INVENTION

The present invention has been developed with the aim to provide a system of static graphic representation applicable to lawn surfaces obviating the stated drawbacks and contributing furthermore other additional advantages which will be obvious from the following description.

Therefore, it is an object of the present invention to provide a system of static graphic representation applicable to lawn surfaces of natural and synthetic type, which may be easily carried out, having a milling device with at least one helical drum with cutting means which permits to cut the lawn.

Particularly, the system is characterised by the fact that it includes guiding means to be located on the lawn surface which guide the displacement of the milling device on the lawn, so that they permit to obtain publicity representations adopting the form of any character or graphic pattern.

It is obvious that the above described system is applicable to any type of installations having a lawn surface and has the advantage that it may use the same machine applied for mowing the lawn simply by means of the adaptation of the milling device.

According to another aspect of the invention, the cutting means consists of a plurality of cutting knives apt to selectively change the inclination angle formed with the horizontal and vertical planes as a function of the graphic representation to be obtained.

Advantageously, the helical drum may include a mechanism for the change of the rotation sense, so that it is apt to change the sense of rotation as a function of the different mowing directions of the lawn and the characteristics of the character and graphic patterns for the area to be cut.

Other advantages and features of the system which is the subject matter of the present invention will be obvious from the description of a preferred embodiment, which is not limitative, having been illustrated as an example in the appended drawings, in which:

### BRIEF DESCRIPTION OF THE DRAWINGS

FIG. 1.—Shows a perspective view of a conventional lawn mower used in the system for graphic representation according to the present invention.

### DESCRIPTION OF A PREFERRED EMBODIMENT

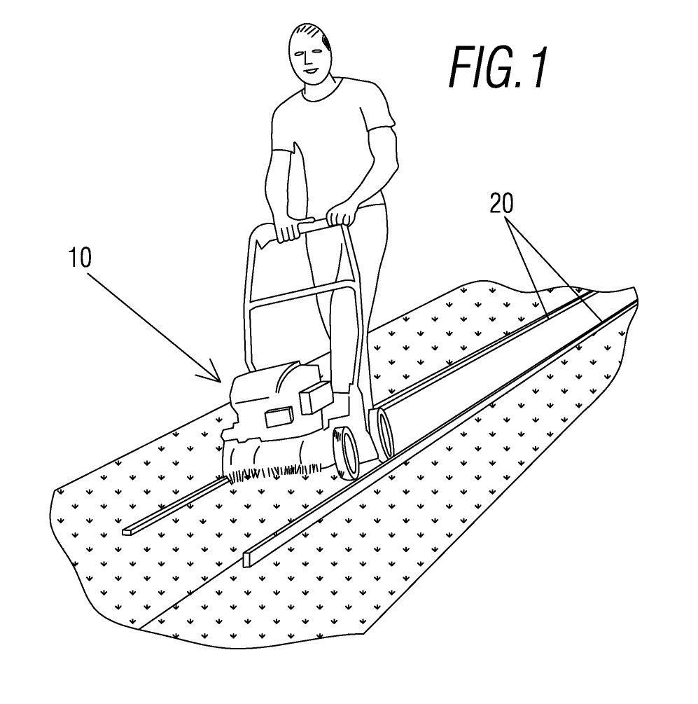

According to a particular embodiment of the invention, the system of static graphic representation applicable to lawn surfaces, both natural and synthetic, comprises a milling device which has a helical drum having cutting means which permit to cut the grass of the lawn. This milling device may be coupled to a hand driven lawn mower, designated generally with (10), or may be incorporated into the same, as shown in FIG. 1. It will be obvious for an expert in the matter that the milling device may be applied to lawn mowing machines of a bigger size having a cab for the operator.

Additionally, guiding means are included to be located on the lawn surface to permit to accurately guide the displacement of the milling device on the lawn surface, so that it may be possible to obtain the previously determined publicity representations on a surface not only by means of cutting the grass, but also by means the inclination of the remaining part of the grass plants after cutting in comparison with the vertical grass plants, this bringing about a shadow or hue effect which permits to obtain a different visualization, for instance a perspective effect of the character or graphic pattern represented on the lawn.

As to the guiding means, these may consist in rails 20 (see FIG. 1), moulds or patterns made out, for instance, of plastic material such as polycarbonate, so as to have a lower weight, facilitating to the user the location and removing of the guiding means in an easy and quick manner with the aim to reduce the time necessary for the preparation of the static pattern representation.

The cutting means (not shown) consists essentially of a plurality of conventional cutting knives apt to change the inclination angle in respect to the horizontal and vertical planes as a function of the graphic representation to be obtained on the lawn surface.

The details, form, dimensions and other accessory elements as well as the materials applied to the manufacture of the system of the invention, may be readily substituted by other technically equivalents which do not depart from the essentials of the invention nor from the scope defined by the following claims.

1. System of static graphic representation, applicable to lawn surfaces of natural or synthetic type, comprising a milling device with at least one helical drum having cutting means to cut the lawn, wherein the system comprises guiding means to be located on the lawn surface, to guide the displacement of the milling device on the lawn surface so as to permit to obtain publicity representations by way of any character or graphic pattern.

2. System of static graphic representation, according to claim 1, wherein the cutting means comprises a plurality of cutting knives apt to change the inclination angle in respect to the horizontal and vertical planes as a function of the graphic representation to be obtained.

3. System of static graphic representation, according to claim 1, wherein the guiding means comprises rails, moulds, templates or similar, made out of plastic material.

4. System of static graphic representation, according to claim 1, wherein the at least one helical drum includes a mechanism for changing the rotation sense, so that it is apt to be changed as a function of the different directions in which the lawn is being cut and the characteristics of the character or graphic pattern of the area to be cut.
